(19) United States
(12) Patent Application Publication
(10) Pub. No.: US 2006/0062886 A1
(43) Pub. Date: Mar. 23, 2006

(54) Instant tea powder

(76) Inventor: Brian Takeda, Vancouver (CA)

Correspondence Address: Clifford W. Vermette;Vermette & Co., 200 Granville Street - Suite 230, Box 40 Granville Square, Vancouver, BC, V6C 1S4, CA

(21) Appl. No.: 10/946,002

(22) Filed: Sep. 22, 2004

(51) Int. Cl. A23F 3/00

(52) U.S. Cl. 426/597

(57) ABSTRACT

An instant tea powder having the full nutritional content of the original tea leaves. The instant tea powder is made up of finely ground tea leaves mixed with a powdered or particulate edible agent, such as sugar, which prevents clumping or coagulation of the powdered tea leaves.

### FIELD OF THE INVENTION

The present invention relates to a powdered tea and, more specifically, to a powdered tea retaining all of the nutritional content of the tea leaves, and which is resistant to clumping.

### BACKGROUND OF THE INVENTION

Instant powdered teas (i.e. instant tea) are typically produced via a complicated infusion, extraction and reduction process before becoming a final product sold in retail stores. It is a highly capital-intensive process requiring specialized equipment having little or no alternative application. It also involves a cumbersome series of operations, adding to the costs and time of manufacturing instant teas. Existing methods all exhibit some or all of the above-mentioned disadvantages.

A further drawback of the prior art instant powdered teas is that a large proportion of the nutrients, including vitamins, minerals, antioxidants and catechins, are lost during the process of making the instant tea powder. Prior art processes extract only the flavour and colour of the tea from the leaves. This makes the prior art instant tea products substantially inferior in nutritional value to freshly brewed teas. Examples of such prior art processes are described in U.S. Pat. Nos. 5,612,079 and 5,683,736.

U.S. Pat. No. 5,538,750, issued to Yamaguchi et al., discloses a method for producing a soluble powder characterized by condensing a tea extract solution by means of a reverse osmosis membrane to make a solution with a solids content of 5 weight % or more, adding and mixing a powder of tea leaves therein, subjecting the obtained mixture to foam-containing freezing step and then freeze-drying it after adjusting particle size. The process disclosed by the '750 patent provides an advantage over the prior art in that it produces an instant tea retaining a greater proportion of the nutrients than other prior art processes. However, the process of the '750 patent is complex, requiring heavy capital investment in specialized equipment, thereby significantly increasing the cost of the final product.

U.S. Pat. No. 6,589,575, discloses a cold water soluble black leaf tea, however, the process disclosed requires the treatment of the tea leaves with solubilizing and oxidizing compounds including ascorbic acid, dehydrated droascorbic acid, 1-scorbamic acid, 5-phenyl-3, 4-diketogamma-butyrolactone, oxidative enzymes and hydrogen peroxide. Such a process, while it may produce a tea having the acceptable color and flavour, results in the oxidation and, therefore, loss of many of the nutrients found in the tea leaves.

A form of ceremonial tea known in the prior art is referred to as ‘matcha’ or ‘maccha’. Matcha is a finely ground powder of green tea leaves that is dissolved in water and consumed. Due to the particle size of matcha, humidity and mutual electrostatic attraction between particles can cause it to form clumps. When rehydrated, the clumping becomes even more apparent, resulting in an uneven (non-homogeneous) product. This results in a tea inferior in appearance, taste, nutritional content and results in waste of tea (i.e. the tea is not dissolved in the water, nor are the nutrients absorbed by the body). Therefore, special care must be taken in its preparation, wherein a specialized whisk and bowl are used to ensure that the tea powder is properly suspended in the water. Matcha is by no means an instant tea; its preparation is time-consuming and requires special care and expensive accessories (e.g. a bamboo whisk, bowl, specialized storage containers, etc.).

Accordingly, it is an object of the present invention to provide an instant tea powder and a process for the manufacture thereof that is simple and cheap, that results in a homogeneous product that does not clump, and that retains the maximum nutritional value of the tea.

### SUMMARY OF THE INVENTION

The present process for making an instant tea powder involves the grinding up of tea leaves into a fine powder, and avoids extraction, reduction, freeze drying, and other complicated and costly processes. The fine powder obtained by grinding the tea leaves is mixed with a powdered agent or combination of agents, such as sugars, salts, herbs, spices and powdered milk, to prevent clumping or coagulation of the tea leaf powder. By preventing clumping, the solubility of the powdered tea leaves is improved, thereby enhancing the ease of preparation, nutritional content, flavor, and appearance of the tea made from the instant tea powder of this invention. Because the present process uses ground up tea leaves rather than a powdered tea extract, all the natural nutrients found in the tea leaves are retained.

The present process of making instant tea does not involve the infusion, extraction, reduction or dehydration steps of the prior art while at the same time solving the problems of clumping and nutrient deficiency. The existing paradigm of the prior art is that the tea flavors must be extracted from dried, loose teas and then somehow made into a powder form. The present invention challenges this assumption and changes variables that have historically been seen as fixed.

### DETAILED DESCRIPTION

Stage #1: Using Finely Ground Tea Leaves

The process of the present invention can be broken into two basic stages. The first stage produces finely ground tea leaves. Historically, tea leaf powders have been made by grinding dried tea leaves in granite stone grinding mills. This process often yields tea leaf particles between the 5 micron and 10 micron level. Newer technologies such as pressure pulverization, if done repeatedly, can reduce the particle sizes to the <5 micron range. The present invention involves the grinding of tea leaves, using known methods, to a particle size of approximately 5-30 μm, and preferably to a size of 5-15 μm.

U.S. Pat. No. 6,416,803, issued to Shibata, (the specification of which is hereby incorporated by reference) is one example of a more refined method of finely grinding tea leaves to a powder having particle sizes of <1 μm using a combination of rubbing, twisting, grinding in a ball mill, and screening. However, the method of Shibata is labor-intensive and therefore an expensive one, involving 12 different stages, including, rubbing, twisting, drying, grinding, screening, spraying, etc., and further involves the moistening of the tea leaf powder by spraying water onto it, and subsequently agitating the moistened powder and irradiating it with infrared radiation.

Regardless of the method used to grind the tea leaves down to the desired particle size, in the present invention the tea leaf powder is not infused, extracted, irradiated or reduced. Rather, the tea leaf powder remains a finely ground tea in which the particles are ground to microscopic levels and which retain virtually all of the natural nutritional value of the original tea leaves.

Stage #2: Blending Agent to Prevent Coagulation

The second stage is to blend the tea leaf powder with an agent, which compensates for the clumping caused by humidity and static electricity, to form the instant tea powder. Protein powder, sugar, calcium powder, dehydrated milk powder or any one or more of several other consumable particulate or powdered agents is blended with the tea leaf powder. The agent need not be soluble. The agent can have any of a wide range of particle sizes determined, for example, by solubility, taste, and aesthetic considerations. Using white sugar as an example, any grade of sugar may be used from icing sugar to coarse granulated sugar. Agents having a particle size larger than granulated sugar or smaller than icing sugar may also be used.

The tea leaf powder and agent are blended together to ensure the tea leaf powder and agent are evenly mixed. As the tea leaf powder and agent are in dry form, simple stirring and mixing should be sufficient to achieve a homogenous mixture or and/or a uniform consistency. The proportion of tea leaf powder to agent is variable, and may be determined by ambient humidity, desired taste of the final product, tea leaf and agent particle size, etc.

In addition to its ability to absorb moisture, the primary considerations in selecting an appropriate agent are that it should not negatively affect the taste, appearance, solubility or nutritional content of the tea.

Hence, by blending in an agent that interferes with the mutual attraction of the tea leaf particles caused by humidity and static electricity, the problem of tea leaf powder particles forming clumps is resolved. The result is an instantly soluble powdered tea beverage that retains all of the nutritional value of the tea leaves.

U.S. Pat. No. 5,538,750 discloses the addition of a tea leaf powder to a condensate of a tea extract solution in order to improve appearance and flavor. The tea leaf powder of the '750 patent is described as being 20-mesh (840 μm) or less, of which at least 50 weight % is 100 mesh (149 μm) or less. In contrast, the present invention involves the grinding of tea leaves to a particle size of approximately 5-30 μm, and preferably to a size of 5-15 μm. The '750 patent further states that the tea leaf powder preferably makes up 0.1 to 20 weight % of the instantly soluble powder as a final product (i.e. 80 to 99.9 weight % is made up of the condensate of the tea extract solution). Because the tea leaf powder makes up only a small percentage of the composition, the nutritional content of the instant tea powder of the '750 patent is far lower than that of the instant tea powder of the present invention. The '750 patent states that if the amount of tea leaf powder used exceeds the stated range, the appearance of the powdered tea product is compromised. Finally, the '750 patent teaches foam freezing and further processing of the mixture of the tea leaf powder and condensate.

Preparation of the instant tea powder of the present invention for consumption simply requires the addition of a hot or cold liquid, such as water, milk or soy milk, to the instant tea powder and stirring. The time required for stirring and/or for the agent and tea to dissolve will depend on factors such as the type of agent used, the type of liquid used, and the temperature of the liquid.

Accordingly, while this invention has been described with reference to illustrative embodiments, this description is not intended to be construed in a limiting sense. Various modifications of the illustrative embodiments, as well as other embodiments of the invention, will be apparent to persons skilled in the art upon reference to this description. It is therefore contemplated that the appended claims will cover any such modifications or embodiments as fall within the true scope of the invention.

1. An instant tea powder, comprising:
a) tea leaf powder made by grinding tea leaves to a particle size of 5-30 μm; and
b) an edible powdered or particulate agent operative to prevent clumping of said tea leaf powder;
wherein said tea leaf powder and said agent are mixed with one another so that said instant tea powder has a uniform consistency.

2. The instant tea powder of claim 1, wherein said tea leaf powder has a particle size of 5-15 μm.

3. The instant tea powder of claim 1, wherein said agent is selected from the group consisting of sugar, salt, dehydrated milk, spices, herbs and protein powder.

4. The instant tea powder of claim 1, wherein said tea leaf powder is a green tea leaf powder.

5. The instant tea powder of claim 1, wherein said agent is operative to absorb humidity.

6. A method of making an instant tea powder, comprising:
a) providing a tea leaf powder having a particle size of 5-30 μm;
b) providing an edible powdered or particulate agent; and
c) mixing said tea leaf powder and said agent with one another so that said instant tea powder has a uniform consistency;
wherein said agent is operative to prevent clumping of said tea leaf powder.

7. The method of claim 6, wherein said tea leaf powder has a particle size of 5-15 μm.

8. The method of claim 6, wherein said agent is selected from the group consisting of sugar, salt, dehydrated milk, spices, herbs and protein powder.

9. The method of claim 6, wherein said tea leaf powder is a green tea leaf powder.

10. The method of claim 6, wherein said agent is operative to absorb humidity.
